(19) United States
(12) Patent Application Publication
(10) Pub. No.: US 2013/0177295 A1
(43) Pub. Date: Jul. 11, 2013

(54) ENABLING COPY AND PASTE FUNCTIONALITY FOR VIDEOS AND OTHER MEDIA CONTENT

(71) Applicant: Jeremy Edward Cath, Redmond, WA (US)

(72) Inventor: Jeremy Edward Cath, Redmond, WA (US)

(73) Assignee: MICROSOFT CORPORATION, Redmond, WA (US)

(21) Appl. No.: 13/345,752

(22) Filed: Jan. 9, 2012

(51) Int. Cl. H04N 9/80

(52) U.S. Cl. 386/241; 386/E09.011

(57) ABSTRACT

Concepts and technologies are described herein for enabling copy and paste functionality for videos and other media content. In accordance with the concepts and technologies disclosed herein, text associated with media content can be displayed in an interface via which the text can be selected, exported, copied, and/or pasted into application programs. In some embodiments, the media content includes a payload and metadata. The metadata can define the text to be displayed. The metadata also can define timing information, styles information, positioning information, actions, and/or other aspects of the text. Output including the payload and the overlay can be generated and presented or stored.

BACKGROUND

Some media files such as training videos, recorded books, and the like, include or reference information that may be helpful to consumers. For example, a training video for repairing a device may include various steps a user will undertake to repair the device. To repair the device, the user may watch the video and pause the video at each step. The video may reference various steps or operations that are to be undertaken during the repair. The actual steps, however, may or may not be shown during the video.

Furthermore, even if text is read or shown in an audio or video file, there may be no convenient way to obtain the text in a usable form. In particular, the user may transcribe the text to a text file, or the like, but may be required to pause or stop the media file to allow time to complete such operations. These and other approaches to obtaining text included in media content can be distracting and/or difficult to complete. Furthermore, the text displayed or heard in media content may or may not be complete, or other text not displayed or otherwise included in the media content may be relevant.

It is with respect to these and other considerations that the disclosure made herein is presented.

### SUMMARY

Concepts and technologies are described herein for enabling copy and paste functionality for videos and other media content. In accordance with the concepts and technologies disclosed herein, text associated with media content can be displayed in an overlay or other interface, and the text can be selected, exported, copied, and/or pasted by users, In some embodiments, the media content includes a video having a payload and metadata. The metadata can define the text to be displayed, as well as timing, positioning, styling, and/or other variables associated with the text. An overlay engine can be configured to receive the media content, analyze the metadata, if present, and generate the overlay.

In some embodiments, the overlay engine analyzes the metadata and determines the text and/or timing information. The overlay engine generates output that includes the payload of the media content, as well as the overlay generated by the overlay engine. Because the functionality of the overlay engine can be provided by various types of computing devices, the output can be hosted by the overlay engine or displayed at the overlay engine,

According to one aspect, an overlay engine is configured to execute a playback application for playback of a video. The video is obtained by the overlay engine from a local or remote storage device. The overlay engine determines if the video includes metadata relating to text to be displayed with the video. If the metadata is not present, the overlay engine can determine if text is displayed in the video and detect the text using various character recognition processes. If the metadata is present, the overlay engine can analyze the metadata to determine contents, timing, and/or other aspects of the text to be displayed.

According to another aspect, the overlay engine is configured to generate the overlay. The overlay can be generated as a layer to be displayed with, or superimposed on, the video during playback. The overlay can be presented as a text box and the video content can be scaled or maintained in its original size, according to various implementations. The overlay engine is configured to generate output including the payload or other video contents and the overlay. The output can be displayed at the overlay engine or stored or hosted for other devices.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an illustrative operating environment for the various embodiments disclosed herein,

FIG. 2 is a flow diagram showing aspects of a method for enabling copy and paste functionality for videos, according to an illustrative embodiment.

FIGS. 3A-3E are user interface diagrams shoeing aspects of illustrative user interfaces for enabling copy and paste functionality for videos, according to various embodiments.

FIG. 4 is a computer architecture diagram illustrating an illustrative computer hardware and software architecture for a computing system capable of implementing aspects of the embodiments presented herein.

FIG. 5 is a diagram illustrating a distributed computing environment capable of implementing aspects of the embodiments presented herein.

FIG. 6 is a computer architecture diagram illustrating a computing device architecture capable of implementing aspects of the embodiments presented herein.

### DETAILED DESCRIPTION

The following detailed description is directed to concepts and technologies for enabling copy and paste functionality for videos and other media content. According to the concepts and technologies described herein, text associated with videos or other media content can be displayed in an overlay such as a text box, a text window, and/or other interfaces. From the presented interface, the text can be selected, exported, copied, and/or pasted by users. Additionally, the displayed text can include various actions such as print options, hyperlinks, and/or other actions that can be taken from within the interface.

In some embodiments, the media content includes a video file, an audio file, or other content having a payload. The media content also can include metadata defining the text to be displayed and timing, positioning, styling, actions, and/or other variables associated with the text. A computing device such as an overlay engine can be configured to receive the media content, analyze the metadata, if present, and generate the overlay. According to some implementations, the overlay engine analyzes the metadata and determines the text and/or timing information. The overlay engine generates output that includes the payload of the media content, as well as the overlay generated by the overlay engine. Because the functionality of the overlay engine can be provided by various types of computing devices, the output can be hosted by the overlay engine or displayed at the overlay engine.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodology for enabling copy and paste functionality for videos will be presented.

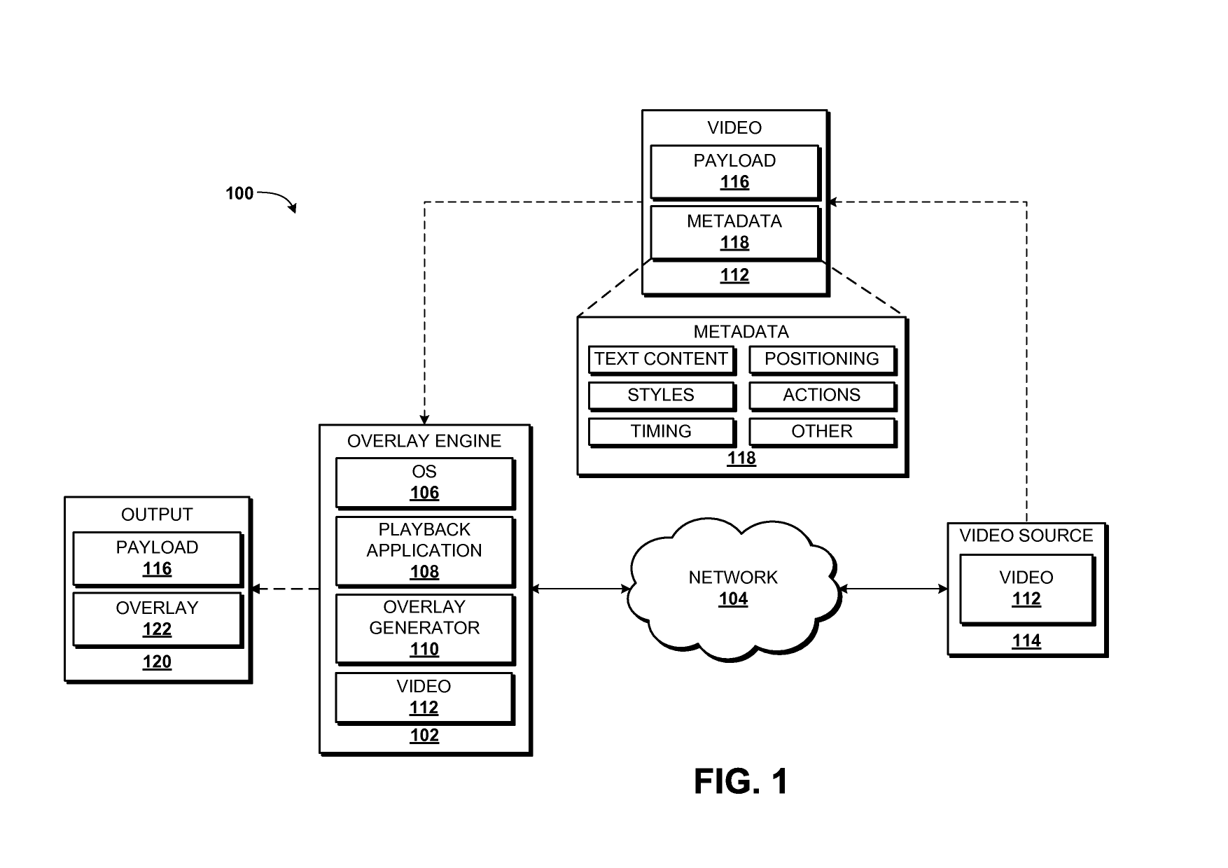

Referring now to FIG. 1, aspects of one operating environment 100 for the various embodiments presented herein will be described. The operating environment 100 shown in FIG. 1 includes an overlay engine 102. In some embodiments, the overlay engine 102 operates on or in communication with a communications network (“network”) 104, though this is not necessarily the case. According to various embodiments, the functionality of the overlay engine 102 is provided by a personal computer (“PC”) such as a desktop, tablet, or laptop computer system. In other embodiments, the functionality of the overlay engine 102 is provided by other types of computing systems including, but not limited to, one or more server computers, handheld computers, netbook computers, embedded computer systems, personal digital assistants, mobile telephones, smart phones, or other computing devices. Thus, while the functionality of the overlay engine 102 is described herein as being provided by a user computing device such as a PC, it should be understood that this embodiment is illustrative, and should not be construed as being limiting in any way.

According to various embodiments, the overlay engine 102 is configured to execute an operating system 106 and one or more application programs such as, for example, a playback application 108, an overlay generator 110, and/or other application programs. The operating system 106 is a computer program for controlling the operation of the overlay engine 102. The application programs are executable programs configured to execute on top of the operating system to provide various functions. In particular, the playback application 108 is an executable program configured to provide an interface for accessing, viewing, and/or controlling various playback options during viewing of a video 112. While the concepts and technologies disclosed herein are described with respect to the video 112, it should be understood that the various embodiments disclosed herein also can be used to enable copy and paste functionality for other media content such as animations, slide shows, images, music, combinations thereof, or the like.

According to various implementations, the functionality of the playback application 108 is provided by a member of the WINDOWS MEDIA PLAYER family of media playback applications from Microsoft Corporation in Redmond, Wash., a member of the QUICKTIME family of media playback applications from APPLE CORPORATION in Cupertino, Calif., a member of the REALPLAYER family of media playback applications from RealNetworks, Inc. in Seattle, Washington, or the like. The functionality of the playback application 108 also can be provided by a web browser, standalone application, or other program for playing and/or viewing various formats of media files including, but not limited to, files formatted as in the SHOCKWAVE or FLASH file formats from Adobe Systems Incorporated in San Jose, Calif., files formatted as HTML5 <video> elements, other formats, or the like. Because the functionality of the playback application 108 can be provided by a wide range of media playback applications, it should be understood that the above list is not exhaustive and merely sets forth some contemplated examples of application programs that can provide the functionality of the playback application 108. As such, the above examples are illustrative and should not be construed as being limiting in any way.

According to various embodiments, the overlay engine 102 is configured to receive or store the video 112. In some embodiments, the video 112 is stored at the overlay engine 102 in a memory or other data storage device. In some embodiments, such as the embodiment illustrated in FIG. 1, the video 112 can be obtained from a video source 114 that is operating as part of and/or in communication with the network 104. The video source 114 can be a network hard drive, a server computer operating on the network 104 or in communication therewith, a virtual storage resource, and/or other storage component. The video 112 can be received and/or stored at the overlay engine 102 and can be imported or accessed by the playback application 108 for playback, editing, and/or for other purposes.

According to various embodiments, the video 112 includes a payload 116 and metadata 118. The payload 116 can correspond to video content of the video 112. Thus, for example, the payload 116 can include a number of images. In some embodiments, the payload 116 also includes audio data such as an audio track. Because the video 112 can correspond to other types of media, it should be understood that other types of data can be included in the video 112 as the payload 116.

The metadata 118 can include various data for describing the video 112, as well as various data describing text that is to be displayed with the video 112 as described herein. As such, the metadata 118 can include traditional types of metadata that may be associated with media files such as headers, codec information, and the like. The metadata 118 also can include various types of information relating to the text. In particular, as shown in FIG. 1, the metadata 118 can include, but is not limited to, text content information, styles information, timing information, positioning information, actions information, and/or other information.

The text content information can include data describing text that is to be displayed with the video 112. The text content information can include any letters, numbers, and/or other characters. For example, a video author may create a video 112 directed to explaining a script or code snippet that is to be explained in the video 112. The video author can include text content information in the metadata 118 that includes sample code, scripts, and the like. As such, as will be explained in further detail herein, a viewer can copy and paste a sample of the code or script instead of trying to transcribe the text to a text file, or the like. Similarly, the text content information can include assembly instructions, repair instructions, recipes, technical specifications, biographical information, source information, and/or any other information that a video author wishes to make available to a viewer during viewing of the video 112. It should be understood that more than one instance of text can be displayed in a particular video 112 and/or a single instance of text can be displayed more than once. As such, the text content information can include data describing one or more instances of text.

The styles information can include various styling information relating to the text. For example, the styles information can include data relating to text fonts, sizes, colors, and the like. The styles information also can include data describing text formatting, and therefore can include, for example, line breaks, tab breaks, and the like, as well as other formatting information relating to the text. Because the styles information can include any type of styling information, it should be understood that these embodiments are illustrative, and should not be construed as being limiting in any way.

The timing information can include data that describes when, during the playback of the video 112, the text is to be displayed. Thus, a video author can specify a particular time during playback that the text is displayed, a duration for which the text is displayed, a time at which the text is hidden, and/or other timing information. As mentioned above, the video 112 can include more than one instance of text to be displayed during playback of the video 112, and a single instance of text can be displayed more than one time. As such, the timing information can specify, for each instance of text, one or more times and/or durations for which the instances of the text are to be displayed.

The positioning information can include data that describes where, relative to the video, the text is to be displayed. In some embodiments, as will be explained in more detail below, the overlay engine 102 can be configured to generate output 120 for displaying the text with the payload 116 of the video 112. In some embodiments, the text can be displayed as an overlay image or layer (“overlay”) 122 that can be displayed on top of a portion of the video content or in other locations on a display screen. As used herein, the term “overlay” with respect to the overlay 122 is used to refer to a window, region, or other area of the display screen used to display text in a manner that allows a user to select, copy, and/or paste the text.

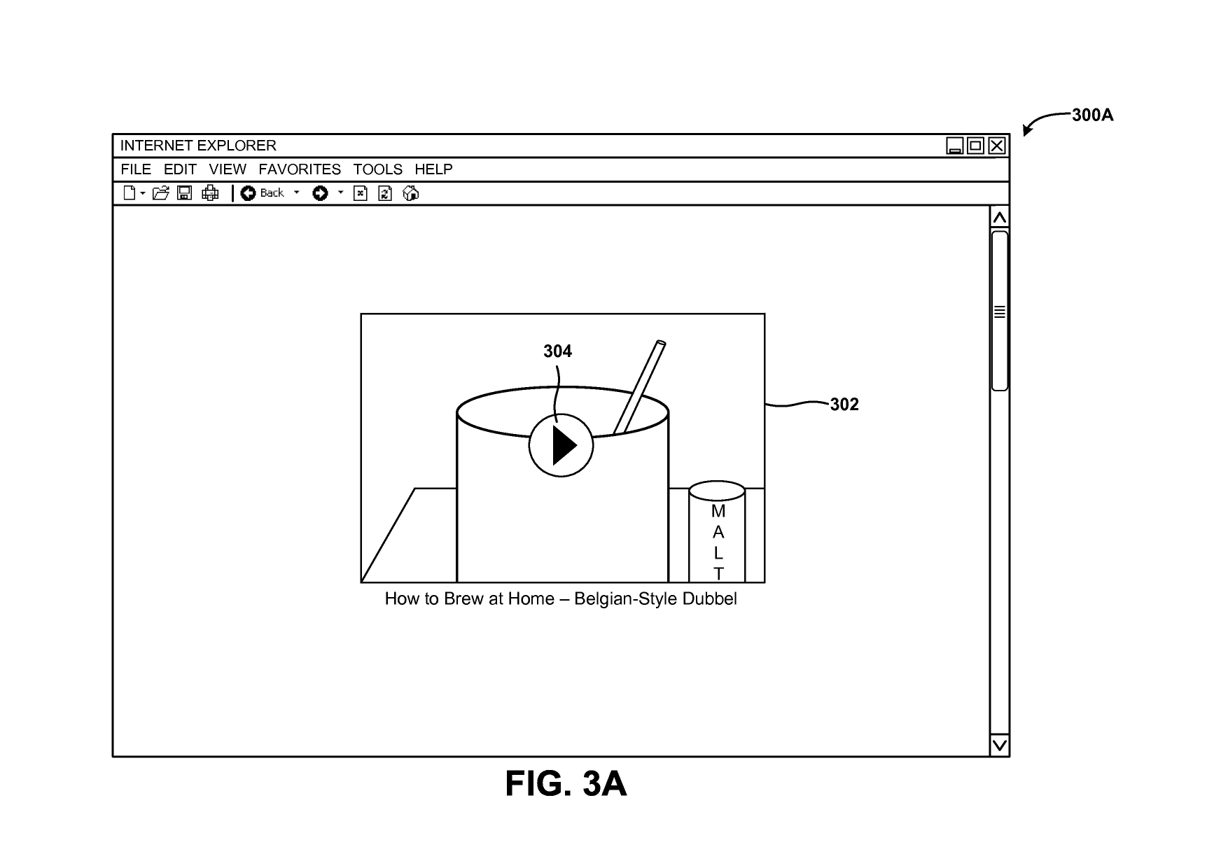

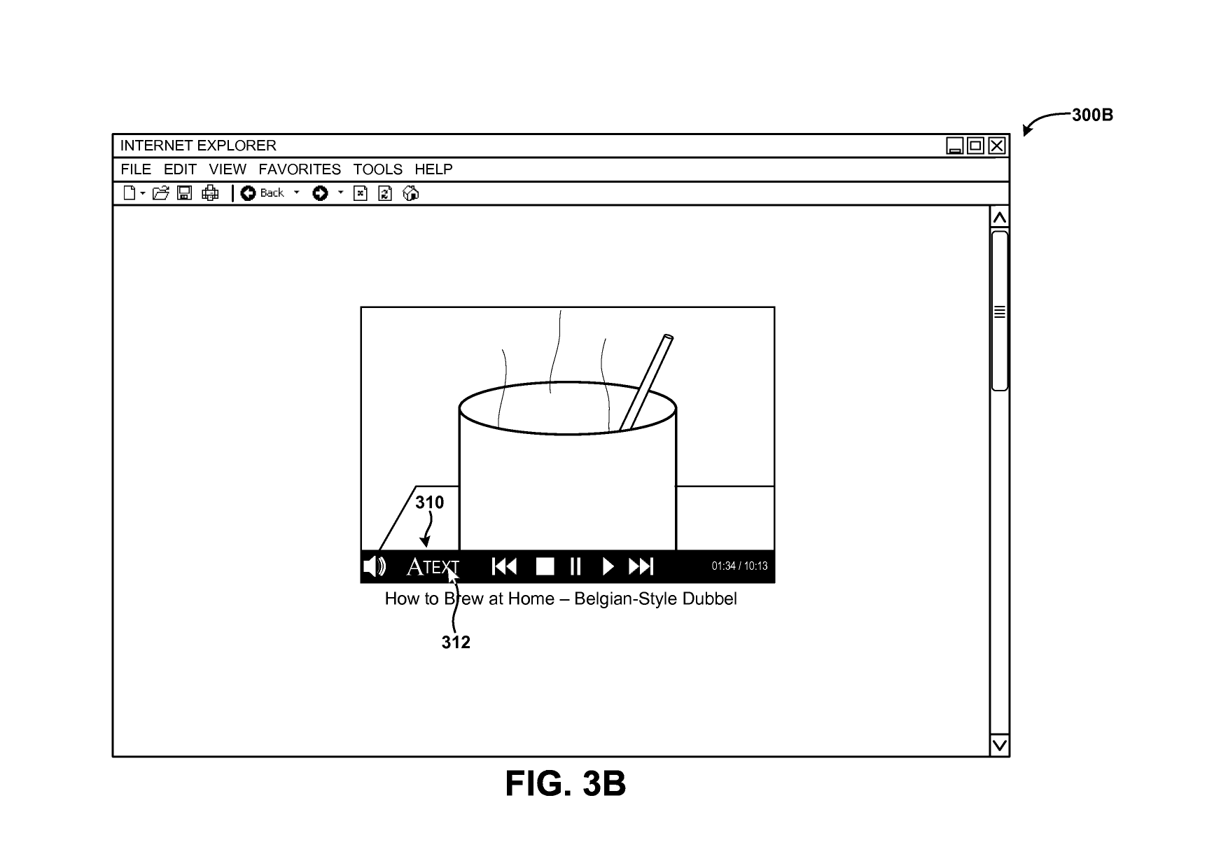

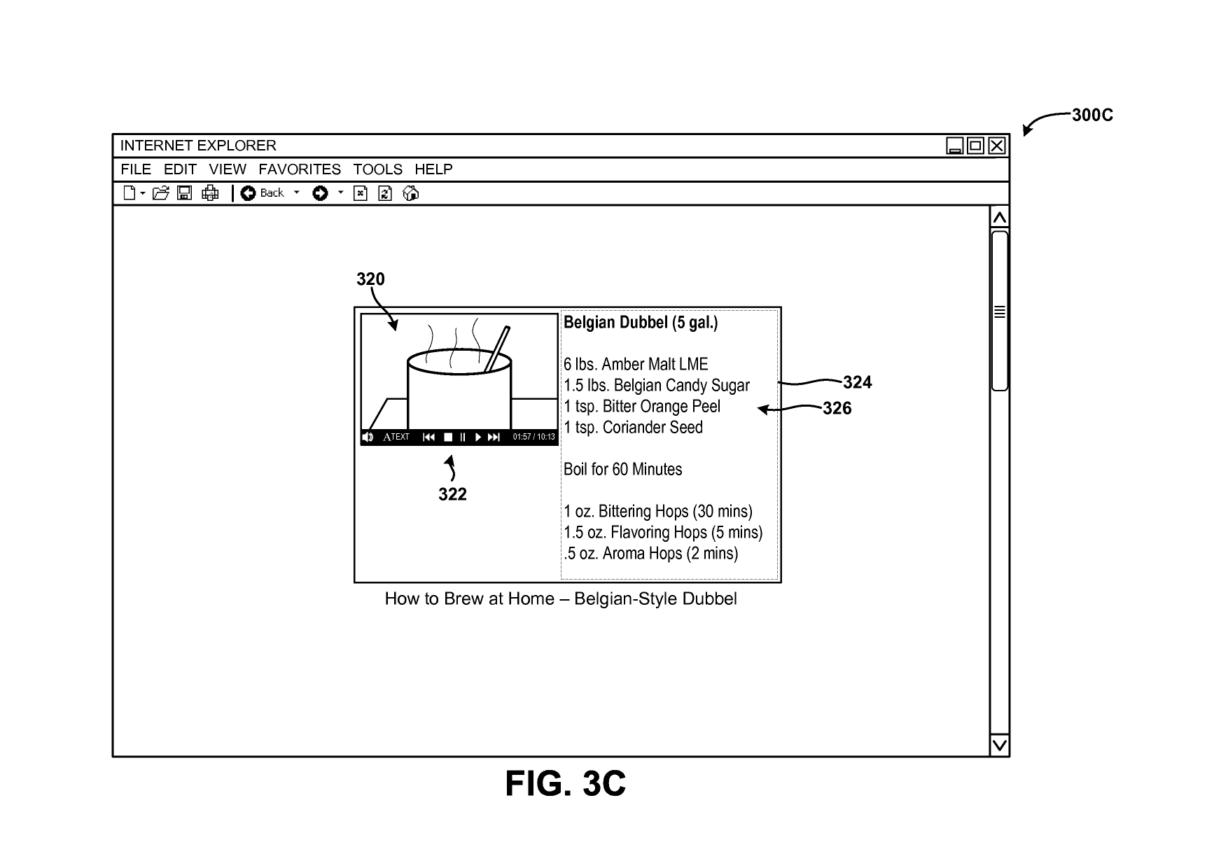

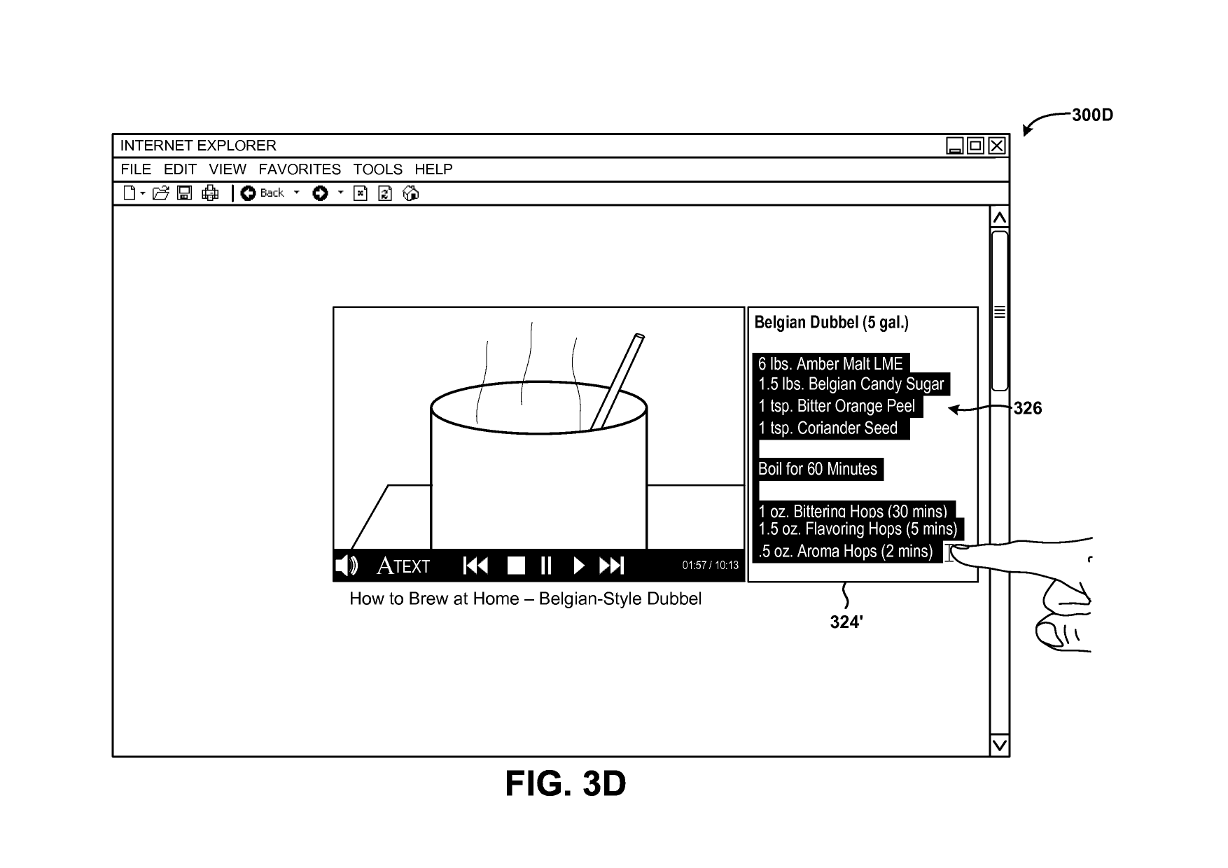

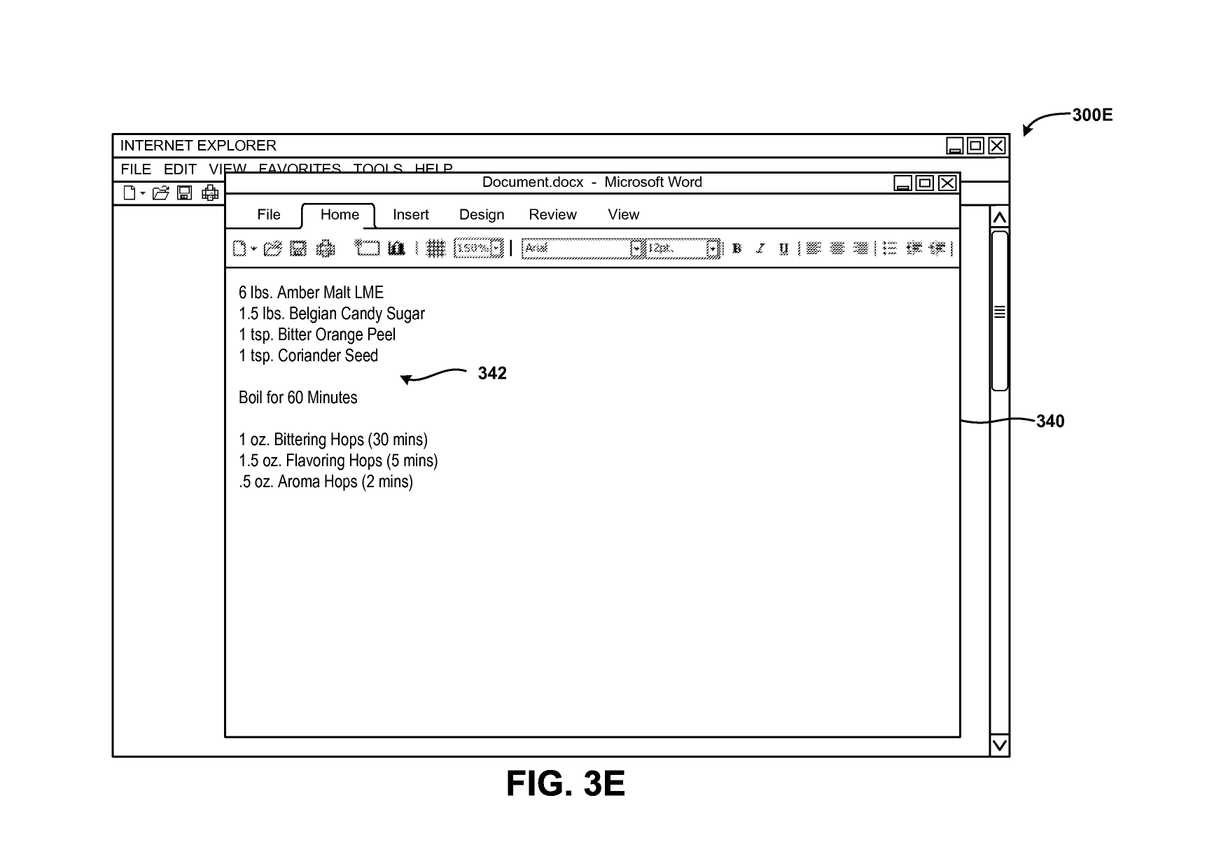

Thus, in some embodiments, the overlay 122 is displayed in a text display window or other area of a screen display that can be separate from an area of the screen display displaying the video content. In yet other embodiments, the video content can be scaled and the overlay 122 can be displayed in a portion of the display screen associated with the video content. An example of this embodiment is illustrated and described below in FIGS. 3B-3C. As such, the positioning information can include data indicating where and how the text is to be displayed. Because any position can be defined by the positioning information, it should be understood that the above-described examples are illustrative, and should not be construed as being limiting in any way.

The actions information can include data defining various actions or functionality that can be included with the text. In some embodiments, for example, the actions information includes hyperlinks or other forms of reference information that, when selected by a user, cause a computing device associated with the user to access or navigate to other locations, files, or other resources. The actions information also can include embedded functionality such as, for example, scripts, applications, and the like, for generating coupons, accessing other information, creating events or contacts in calendars or contact books, downloading files, initiating telephone calls, initiating chat sessions, and the like. Thus, for example, the actions information can include an embedded “print” command for outputting the displayed text to a printer or other writing device. Because various other actions are contemplated and are possible, it should be understood that these embodiments are illustrative, and should not be construed as being limiting in any way.

The other information can include, but is not limited to, headers, codec information, and other data that can be included in the metadata 118. As such, the metadata 118 can include traditional video metadata and/or headers as well as various types of information for defining and describing text to be displayed with the video contents or payload 116 of the video 112. The overlay engine 102 can receive the video 112, analyze the video 112 to determine if metadata 118 is included. Because metadata 118 may be included in the video 112 and may or may not include text information, the overlay engine 102 can analyze the metadata 118 to determine if text information is included. If text information is included in the metadata 118, the overlay generator 110 of the overlay engine 102 can analyze the metadata 118 and format the text for display with the video content.

In particular, the overlay generator 110 can be configured to analyze the metadata 118 to format the text and the output 120, as described herein. It can be appreciated from the above description of the metadata 118 that in some embodiments, the overlay generator 110 can determine, based upon the metadata 118, text contents, styling of the text, timing of the text, positioning of the text, actions associated with the text, and/or other information relating to the video and/or the text. According to implementations, the overlay generator 110 is configured to generate one or more overlays 122 for display with video content such as the payload 116 of the video 112.

The overlays 122 can be included in the output 120. As noted above, the text can include more than one instances of text and therefore the output 120 can include more than one overlay 122 that can be displayed and/or hidden with respect to the payload 116 at various times during display of the video 112 by a viewer. Thus, for example, a first overlay 122 can include a first text instance to be displayed with the video content at a first time and for a first duration and a second overlay 122 can include a second text instance to be displayed with the video content at a second time and for a second duration. It should be understood that the overlay 122 can include multiple instances of text and/or timing, positioning, styling, actions, and/or other information and that, as such, a single overlay 122 can be included in the output 120.

According to embodiments, the overlay engine 102 obtains a video 112. The video 112 can be stored at the overlay engine 102 and/or received from a remote video source 114. The video can include a payload 116 and metadata 118 describing text that is to be displayed with the video content during playback of the video 112. The overlay engine 102 can analyze the video 112 to determine if text is to be displayed and, if so, to generate an overlay 122 for display during playback. The overlay 122 can be displayed with the payload 116 of the video 112 during playback by a media playback program such as the playback application 108.

The overlay engine 102 generates the output 120. In some embodiments, the functionality of the overlay engine 102 is provided by a user device and the output 120 therefore can be displayed at the overlay engine 102. In other embodiments, the functionality of the overlay engine 102 is provided by a server computer or other device configured to generate the output 120 for providing to other entities. As such, the output 120 can be stored to a server, database, or other data storage device for access by users or for other purposes.

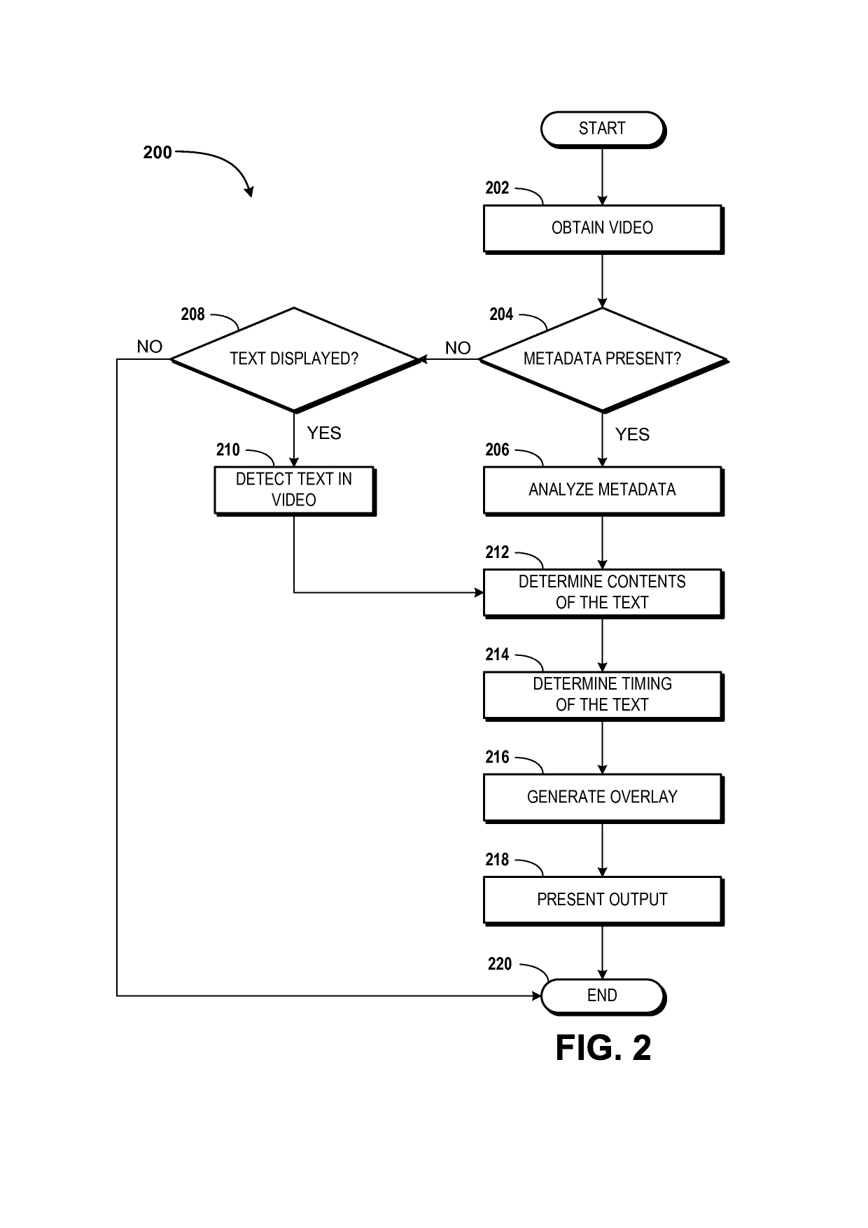

During playback of the output 120, the overlay 122 can be displayed with the payload 116 of the video 112. The overlay 122 can be provided as a text window, text area, or other formatted area that allows selection of the text provided in the overlay 122. As such, viewers can select the text in the overlay 122. The text therefore can be copied by viewers and/or pasted into other application programs such as word processors, email applications, or other software. As mentioned above, the text also can included embedded functionality such as print options and the like, thereby enabling users to copy, paste, print, save, and/or otherwise interact with the text in the overlay 122. The generation and display of the overlays 122, as well as selection, copying, and pasting of the text included in the overlays 122, are illustrated and described in more detail below with reference to FIGS. 2-4.

FIG. 1 illustrates one overlay engine 102, one network 104, and one video source 114. It should be understood, however, that some implementations of the operating environment 100 include multiple overlay engines 102, multiple networks 104, and no or multiple video sources 114. Thus, the illustrated embodiments should be understood as being exemplary, and should not be construed as being limiting in any way.

Turning now to FIG. 2, aspects of a method 200 for enabling copy and paste functionality for videos will be described in detail, according to an illustrative embodiment. It should be understood that the operations of the method 200 disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims,

It also should be understood that the illustrated method 200 can be ended at any time and need not be performed in its entirety. Some or all operations of the method 200, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof

For purposes of illustrating and describing the concepts of the present disclosure, the method 200 is described as being performed by the overlay engine 102 via execution of one or more application programs such as, for example, the playback application 108 and/or the overlay generator 110. It should be understood that these embodiments are illustrative, and should not be viewed as being limiting in any way, In particular, other devices in addition to or instead of the overlay engine 102 can provide the functionality described herein by execution of various application programs in addition to, or instead of, the playback application 108 and/or the overlay generator 110.

The method 200 begins at operation 202, wherein media content such as the video 112 is obtained by the overlay engine 102. As explained above, various implementations of the concepts and technologies disclosed herein can provide overlays 122 for various types of media files including, but not limited to, video files, animation files, slide show files, image files, audio files, other media files, or the like. The method 200 is described with reference to an embodiment wherein the video 112 corresponds to a video file for the sake of clarity. In light of the various embodiments disclosed herein, it should be understood that this embodiment is illustrative, and should not be construed as being limiting in any way.

According to various implementations, the video 112 is obtained from a storage device or component associated with the overlay engine 102. In other embodiments, the video 112 is stored at a remote storage location such as the video source 114 described herein, and obtained by the overlay engine 102 via communications with the video source 114. As such, it should be understood that the video 112 can be obtained from any device via a direct connection, via one or more networks, and/or via other nodes, devices, and/or device components. Also, as explained above in detail with reference to FIG. 1, the video 112 can include the payload 116 corresponding to video content of the video 112. In some embodiments, the video 112 also includes the metadata. 118 described above for defining text to be displayed with the payload 116.

From operation 202, the method 200 proceeds to operation 204, wherein the overlay engine 102 determines if the video 112 includes metadata such as the metadata 118. While various media files can include metadata, the metadata. 118 includes text information for text to be displayed with the video 112. Thus, the overlay engine 102 can determine, in operation 204, if the video 112 includes the metadata 118 for defining text to be displayed with the video 112. As explained above, the overlay engine 102 can identify the metadata 118 by analyzing contents of the video 112 and/or detecting a flag or indicator that the metadata 118 is included. Because other approaches for determining that the video 112 include the metadata 118 are contemplated, it should be understood that operation 204 can include various approaches for detecting presence of the metadata 118.

If the overlay engine 102 determines, in operation 204, that the metadata 118 is present in the video 112 obtained in operation 202, the method 200 proceeds to operation 206. At operation 206, the overlay engine 102 analyzes the metadata 118. The overlay engine 102 can search the metadata 118 to identify various types and/or categories of information relating to formatting the text. The information can include, but is not limited to, the types of information described in FIG. 1 with respect to the metadata 118. As such, the overlay engine 102 can search for variables, tags, settings, or the like for defining text contents, styles information, timing information, positioning information, actions information, and/or other information. In some embodiments, the metadata 118 includes at least text content information. In another embodiment, which is assumed for purposes of describing the method 200, the metadata 118 includes at least the text content information and the timing information described herein. Because other information can be included and/or omitted, it should be understood that this embodiment is illustrative.

Returning to operation 204, if the overlay engine 102 determines that the metadata 118 is not present in the video 112 obtained in operation 202, the method 200 proceeds to operation 208, wherein the overlay engine 102 determines if text is displayed in the video 112. As such, some embodiments of the overlay engine 102 are configured to include functionality for identifying text in the video 112 without using the metadata 118. In some embodiments, for example, the overlay engine 102 can be configured to analyze the video 112 to determine if text is displayed using character recognition and/or other processes. In other embodiments, the overlay engine 102 is configured to provide the functionality of operation 208 in response to detecting a command to extract text from a video 112, in response to detecting a pause of playback of the video 112, or in response to other commands. Thus, the functionality of operation 208 can be provided automatically and/or on-demand, according to various implementations. An example UI control for displaying the overlay 122 and/or for prompting the functionality of operation 208 is described below with reference to FIG. 3B. Because the overlay engine 102 can be configured to detect text in the video 112 in other ways, it should be understood that the above-described embodiments are illustrative, and should not be construed as being limiting in any way.

If the overlay engine 102 determines, in operation 208, that text is not displayed in the video 112 and/or if the overlay engine 102 concludes playback of the video 112 without detecting input for extracting text from the video 112, the method 200 can end. If the overlay engine 102 determines, in operation 208, that text is displayed in the video 112 and/or if input for extracting the text is received, the method 200 can proceed to operation 210, wherein the overlay engine 102 can detect text in the video 112. According to various embodiments, the text can be detected using character recognition such as optical character recognition (“OCR”) or other text detection functionality. Thus, the overlay engine 102 can detect text in the video 112 via analysis of the metadata 118, if included in the video 112, or by using character recognition or other text extraction processes to extract text from the video 112.

From operation 210, the method 200 proceeds to operation 212. The method 200 also can proceed to operation 212 from operation 210. At operation 212, the overlay engine 102 determines contents of the text to be displayed. If the video 112 includes the metadata 118, the overlay engine 102 can determine the text contents based upon the analysis of the metadata 118 in operation 206, wherein the overlay engine 102 can identify the text information and determine, in operation 212, the contents of the text to be displayed. If the video 112 does not include the metadata 118, the overlay engine 102 can detect the text in operation 210 and determine, in operation 212, the contents of the text to be the text detected in operation 210. As noted above, the overlay engine 102 can determine, in operation 212, one or more instances of text included in the metadata 118.

From operation 212, the method 200 proceeds to operation 214, wherein the overlay engine 102 determines a timing of the text content determined in operation 212. If the video 112 includes the metadata 118, the overlay engine 102 can determine the timing of the text by identifying timing information during analysis of the metadata 118 in operation 206. If the video 112 does not include the metadata 118, the overlay engine 102 can determine the timing based upon a time the text is displayed in the video 112 and/or a time at which the command to extract the text is received. Other timing parameters such as time durations for text display, time durations after which text is hidden, or the like, can be defined by user or program settings or options.

As mentioned above, in some embodiments the metadata 118 includes timing information and multiple instances of text. As such, operation 214 can include the overlay engine 102 formatting one or more instances of text determined in operation 212 according to one or more instances of timing information determined in operation 214. As such, some embodiments of operations 212-214 include formatting multiple instances of text to be displayed at multiple times during playback of the video 112.

From operation 214, the method 200 proceeds to operation 216, wherein the overlay engine 102 generates a text display such as, for example, a text window or other text display such as the overlay 122 described herein. In some embodiments, the overlay 122 is formatting in accordance with user, software, or video author settings or options. Thus, in various embodiments the overlay 122 is presented as a text box or window, as an overlay layer, or as another area of a screen display for presenting and/or supporting interactions with the text.

According to various embodiments, the video content of the video can be scaled and the overlay 122 can be displayed in a region of a screen display used to display the video. Thus, for example, if the video 112 may include video content formatted to 720×480 pixels and text information to be presented with the video. The overlay 122 can be formatted for display at 720×480 pixels as a layer on top of the video content and/or the video content can be scaled, for example to a size of 120×80 pixels and the text can be formatted to fill the remainder or a portion of the space within the 720×480 pixels originally dedicated to the video content. An example of the overlay 122 in which the video content is scaled and presented with the overlay 122 is illustrated and described below with reference to in FIG. 3C. In light of the above embodiments wherein the video content is not scaled, it should be understood that this embodiment is illustrative, and should not be construed as being limiting in any way.

From operation 216, the method 200 proceeds to operation :218, wherein the overlay engine 102 presents output such as the output 120. As explained above with reference to FIG. 1, the output 120 can include video content corresponding to the payload 116. The output 120 also can include text, which can be formatted as the overlay 122 and presented with the video content. Examples of presenting the output 120 are illustrated and described in more detail below with reference to FIGS. 3A-3D.

From operation 218, the method 200 proceeds to operation 220. The method 200 also can proceed to operation 220 from operation 208 if the overlay engine 102 determines, in operation 208, that text is not displayed in the video 112 or if playback of the video 112 concludes without receiving a command to extract text from the video. The method 200 can end at operation 220.

Turning now to FIG. 3A, a UI diagram showing aspects of a UI for enabling copy and paste for videos in some embodiments will be described. In particular. FIG. 3A shows a screen display 300A generated by the overlay engine 102 for presenting the video 112 or other media. As such, the screen display 300A shown in FIG. 3A can be generated by the playback application 108 or a media playback application plugin within a web browser or other application program, The screen display 300A also can be generated by the overlay generator 110 and therefore can correspond to the output 120 described above with reference to FIGS. 1-2. It should be appreciated that the UI diagram illustrated in FIG. 3A is illustrative of one contemplated embodiment, and therefore should not be construed as being limited in any way.

In the illustrated embodiment, the screen display 300A is configured to present an interface for playback of the video 112. In the illustrated embodiment, the video 112 is viewed within a web browser. As shown, the web browser is displaying a video window 302. The video window 302 includes a UI control 304 that, when selected, prompts display of the video 112. It should be understood that additional and/or alternative playback controls can be displayed in or near the video window 302 and that the UI control 304 is illustrative. In the embodiment illustrated in FIG. 3A, the overlay engine 102 has presented the output 120. Because playback of the video 112 has not yet commenced in the illustrated embodiment, the payload 116 or other video contents are displayed without the overlay 122 or the overlay 122 is hidden from view until playback commences. In the illustrated embodiment, the overlay 122 is hidden from view but is included as part of the output 120 shown in FIG. 3A. It should be understood that this embodiment is illustrative, and should not be construed as being limiting in any way.

Referring now to FIG. 3B, a UI diagram showing additional aspects of a UI for enabling copy and paste for videos in some embodiments is described in detail. In FIG. 3B, the overlay engine 102 has received a command to play the video 112 and, in response to the command, has begun playback, of the video 112. For example, the screen display 300B can be generated by the overlay engine 102 in response to receiving selection of the UI control 304 shown in FIG. 3A. In the embodiment shown in FIG. 3B, the output 120 is again shown as displayed without the overlay 122 and/or with the overlay 122 still hidden from view. In some embodiments, the illustrated screen display 300B or similar screen displays can be displayed by the overlay engine 102 if text has not yet been detected in the video and/or if playback of the video has not yet arrived at a point of time in the video at which the text is displayed. For example, the timing information can specify a display time of one minute thirty-five seconds, and playback of the video 112 is shown at one minute and thirty four second. As such, FIG. 3B illustrates the video 112 without an overlay 122. It should be understood that this embodiment is illustrative, and should not be construed as being limiting in any way.

As shown in FIG. 3B, some embodiments of the concepts and technologies disclosed herein include presenting a UI control 310 for turning on or turning off functionality associated with the overlay engine 102. As explained above in detail with reference to FIGS. 1-2, the UI control 310 also can be used to prompt the overlay engine 102 to extract text from video 112. The UI control 310 is selectable to extract text from the video and/or to present or hide text associated with the video 112 in a text box or other form of the overlay 122. For purposes of illustrating and describing the concepts and technologies disclosed herein, FIG. 3B illustrates selection of the UI control 310 for example by a user manipulating a mouse pointer 312, though other input mechanisms are contemplated, In response to the input, the overlay engine 102 can present an overlay 122 and/or turn on functionality associated with the overlay engine 102, as will be illustrated and described in more detail below with reference to FIGS. 3C-3E.

Referring now to FIG. 3C, a UI diagram showing additional aspects of a UI for enabling copy and paste for videos 112 in some embodiments is described in detail. FIG. 3C shows a screen display 300C generated by the overlay engine 102 to provide the overlay 122 described herein. FIG. 3C illustrates an embodiment in which the video content associated with the video 112 is scaled to create space for display of the overlay 122 within an original size of the video content or payload 116 of the video 112. As explained above, and illustrated in FIG. 3D, the overlay 122 can be created in other display space. Also, as explained above, the overlay 122 can be superimposed or layered on top of the displayed video content, if desired. As such, the illustrated embodiment is illustrative and should not be construed as being limiting in any way.

In various implementations, the screen display 300C is configured to provide an interface for viewing the payload 116 and for interacting with the overlay 122. In the illustrated screen display 300C, the video content associated with the video 112 is illustrated as displayed in a scaled version of the video content in a scaled video window 320. The scaled video window 320 can include various playback controls 322 for controlling playback of the video 112 and/or for controlling functionality of the overlay engine 102. In some embodiments, the playback controls 322 are displayed elsewhere on the screen display 300C. As such, the illustrated embodiment should be understood as being illustrative, and should not be construed as being limiting in any way.

In the illustrated embodiment, the overlay 122 is displayed as a text window 324 included in the screen display 300C. The text window 324 includes display space for displaying text 326 associated with the video 112. As explained above, the contents of the text 326, the styling and/or formatting of the text 326, the positioning of the text 326 and/or the type and location of the overlay 122, and/or the timing of the display of the overlay 122 can be defined by the metadata 118 or other information. As explained above, the text window 324 or other form of the overlay 122 can support interactions by users to allow the text 326 to be selected and/or copied by viewers. Additionally, though not shown in FIG. 3C, the text 326 can include actions and/or links that can be selected by viewers to take various actions such as navigating to resources, printing the text 326, saving the text 326, exporting the text 326, and/or other operations.

Turning now to FIG. 3D, a UI diagram showing additional aspects of a UI for enabling copy and paste for videos 112 in some embodiments is described in detail, FIG. 3D shows a screen display 300D generated by the overlay engine 102 to provide another embodiment of the overlay 122 described herein, In particular. FIG. 3D illustrates an embodiment in which the video content associated with the video 112 is not scaled and the overlay 122 is displayed elsewhere on the screen display 300D as the text window 324′. It should be understood that the relative location within the screen display 300D of the text window 324′ is illustrative and should not be construed as being limiting in any way, In particular, the text window 324′ can be displayed at any location within the screen display 300D.

As explained above and illustrated in FIG. 3D, the text 326 displayed within the text window 324′ can be selected. While the text window 324 shown in FIG. 3C does not show the text 326 as being selected, it should be understood that the text 326 can be selected from various forms of the overlay 122 including, but not limited to, the text window 324 and/or the text window 324′. The text 326 also can be exported, saved, printed, and/or otherwise interacted with by viewers, as explained above.

Referring to FIGURE 3E, a UI diagram showing additional aspects of a UI for enabling copy and paste for videos 112 in some embodiments is described in detail. In particular, FIG. 3E shows pasting of the text 326 copied from the text window 324′ into an application window 340. Thus, the pasted text 342 can include the text indicated as selected in the screen display 300D. In the illustrated embodiment, the text 326 has been pasted as the pasted text 342 into a word processing document within the application window 340. As explained above in detail, other operations can be taken with respect to the text 326 and this embodiment therefore should be understood as being illustrative. As such, it can be appreciated that the overlay engine 102 can present an overlay 122 or other mechanisms by which text associated with and/or displayed within video 112 can be copied and pasted, as well as made subject to other operations.

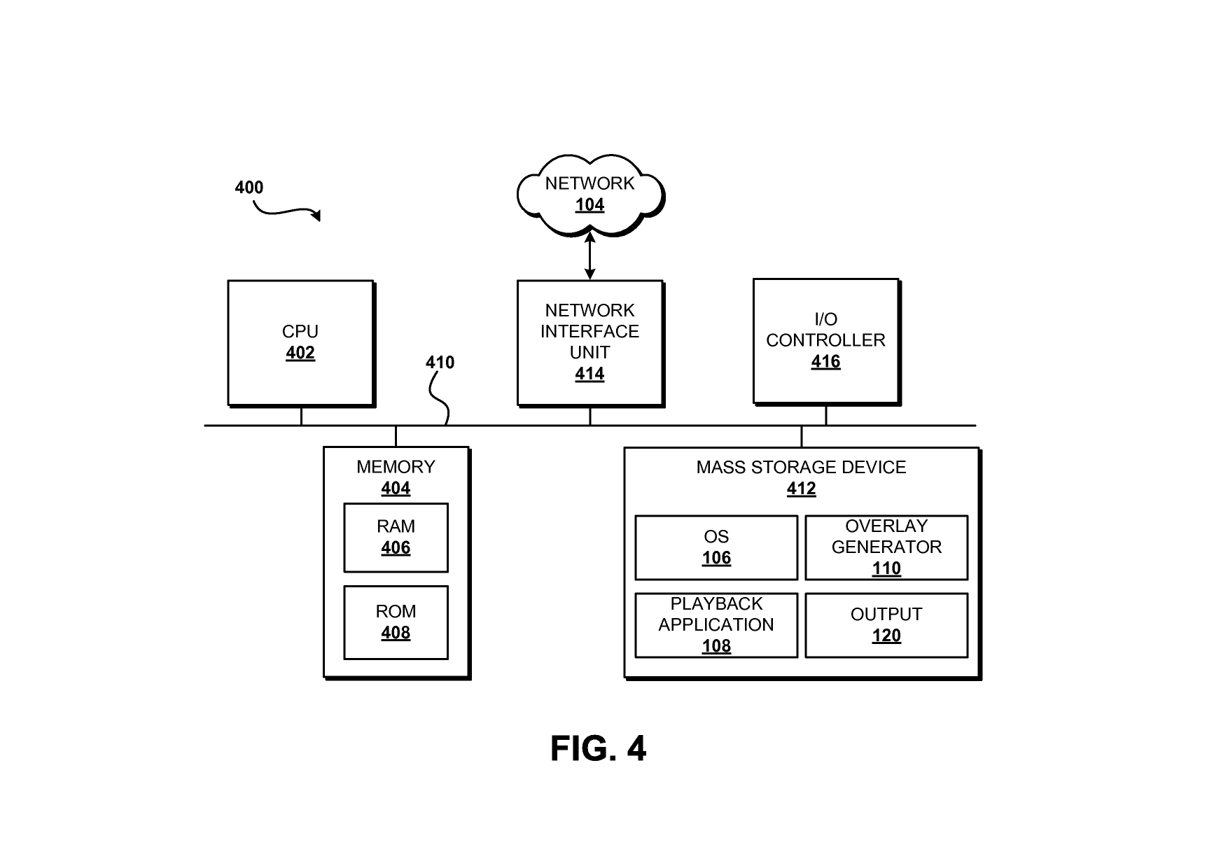

FIG. 4 illustrates an illustrative computer architecture 400 for a device capable of executing the software components described herein for enabling copy and paste functionality for videos. Thus, the computer architecture 400 illustrated in FIG. 4 illustrates an architecture for a server computer, mobile phone, a PDA, a smart phone, a desktop computer, a netbook computer, a tablet computer, and/or a laptop computer. The computer architecture 400 may be utilized to execute any aspects of the software components presented herein.

The computer architecture 400 illustrated in FIG. 4 includes a central processing unit 402 (“CPU”), a system memory 404, including a random access memory 406 (“RAM”) and a read-only memory (“ROM”) 408, and a system bus 410 that couples the memory 404 to the CPU 402. A basic input/output system containing the basic routines that help to transfer information between elements within the computer architecture 400, such as during startup, is stored in the ROM 408. The computer architecture 400 further includes a mass storage device 412 for storing the operating system 106, the playback application 108, the overlay generator 110, and the output 120. Although not shown in FIG. 4, the mass storage device 412 also can be configured to store the video 112 and the various components of the video 112 and/or the output 120, if desired.

The mass storage device 412 is connected to the CPU 402 through a mass storage controller (not shown) connected to the bus 410. The mass storage device 412 and its associated computer-readable media provide non-volatile storage for the computer architecture 400. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 400.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 400. For purposes the claims, the phrase “computer storage medium” and variations thereof, does not include waves, signals, and/or other transitory and/or intangible communication media, per se.

According to various embodiments, the computer architecture 400 may operate in a networked environment using logical connections to remote computers through a network such as the network 104. The computer architecture 400 may connect to the network 104 through a network interface unit 414 connected to the, bus 410. It should be appreciated that the network interface unit 414 also may be utilized to connect to other types of networks and remote computer systems, for example, the video source 114. The computer architecture 400 also may include an input/output controller 416 for receiving and processing input from a number of other devices, including a keyboard, mouse, or electronic stylus (not shown in FIG. 4). Similarly, the input/output controller 416 may provide output to a display screen, a printer, or other type of output device (also not shown in FIG. 4).

It should be appreciated that the software components described herein may, when loaded into the CPU 402 and executed, transform the CPU 402 and the overall computer architecture 400 from a general-purpose computing system into a special-purpose computing system customized to facilitate the functionality presented herein. The CPU 402 may be constructed from any number of transistors or other discrete circuit elements, which may individually or collectively assume any number of states. More specifically, the CPU 402 may operate as a finite-state machine, in response to executable instructions contained within the software modules disclosed herein. These computer-executable instructions may transform the CPU 402 by specifying how the CPU 402 transitions between states, thereby transforming the transistors or other discrete hardware elements constituting the CPU 402.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 400 in order to store and execute the software components presented herein. It also should be appreciated that the computer architecture 400 may include other types of computing devices, including hand-held computers, embedded computer systems, personal digital assistants, and other types of computing devices known to those skilled in the art. It is also contemplated that the computer architecture 400 may not include all of the components shown in FIG. 4, may include other components that are not explicitly shown in FIG. 4, or may utilize an architecture completely different than that shown in FIG. 4.

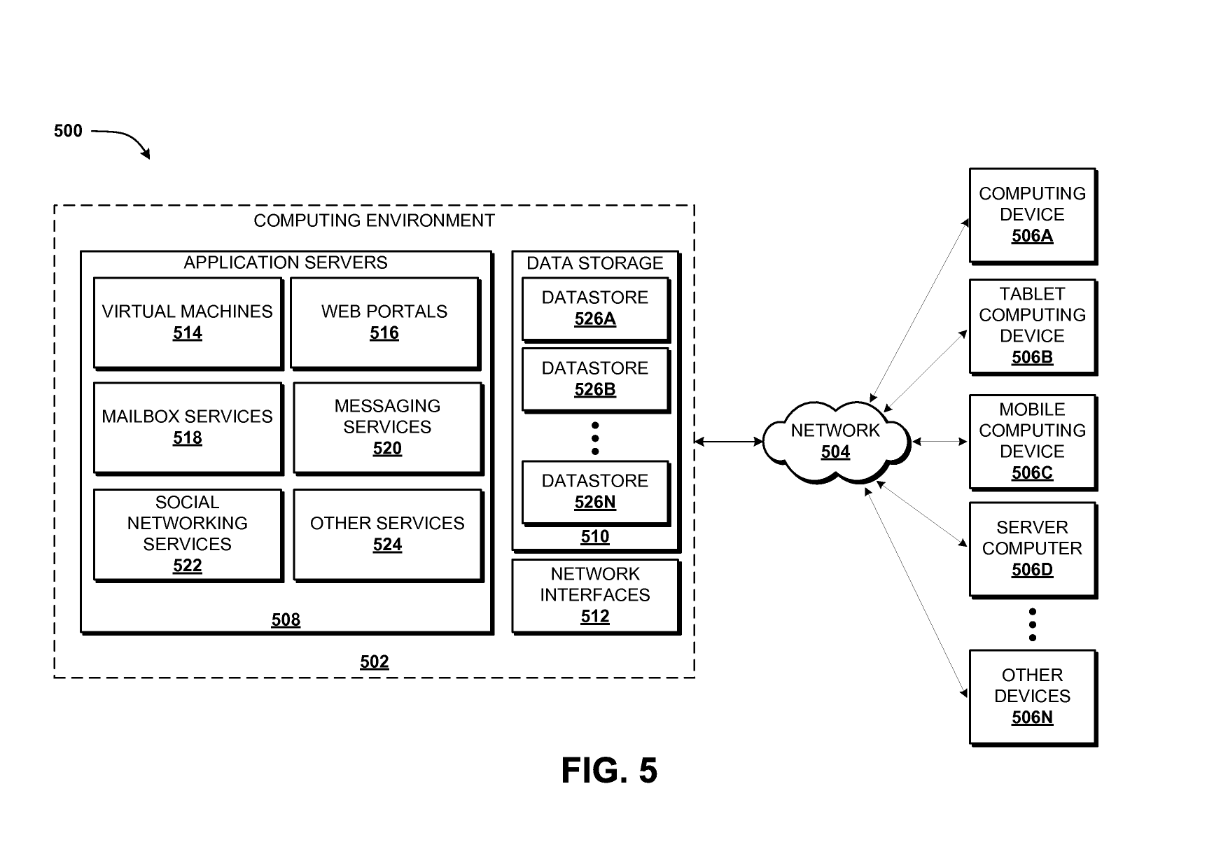

FIG. 5 illustrates an illustrative distributed computing environment 500 capable of executing the software components described herein for enabling copy and paste functionality for videos. Thus, the distributed computing environment 500 illustrated in FIG. 5 can be used to provide the functionality described herein with respect to the overlay engine 102 and/or other devices. The distributed computing environment 500 may be utilized to execute any aspects of the software components presented herein.

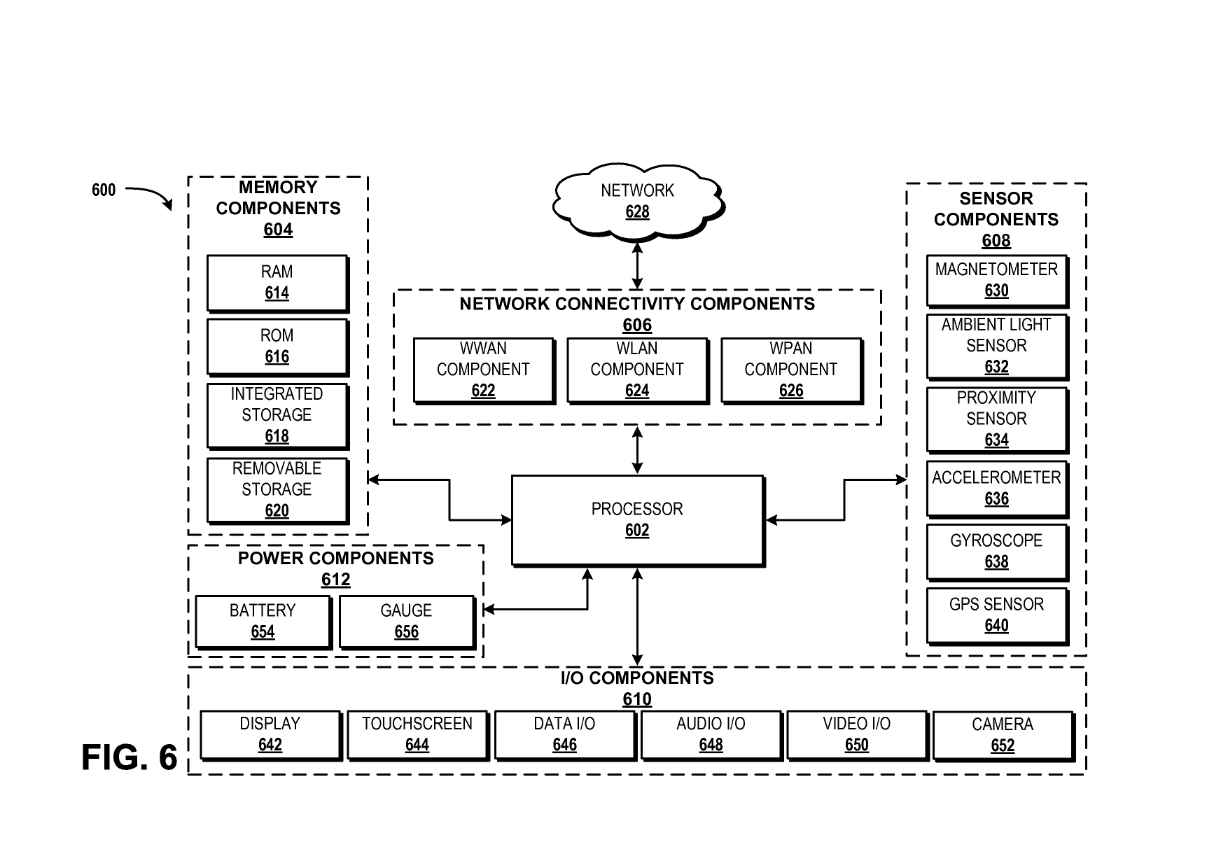

According to various implementations, the distributed computing environment 500 includes a computing environment 502 operating on, in communication with, or as part of the network 504. The network 504 also can include various access networks. According to various implementations, the functionality of the network 504 is provided by the network 104 illustrated in FIGS. 1 and 4. One or more client devices 506A-506N (hereinafter referred to collectively and/or generically as “clients 506”) can communicate with the computing environment 502 via the network 504 and/or other connections (not illustrated in FIG. 5). In the illustrated embodiment, the clients 506 include a computing device 506A such as a laptop computer, a desktop computer, or other computing device; a slate or tablet computing device (“tablet computing device”) 506B; a mobile computing device 506C such as a mobile telephone, a smart phone, or other mobile computing device; a server computer 506D; and/or other devices 506N. It should be understood that any number of clients 506 can communicate with the computing environment 502. Two example computing architectures for the clients 506 are illustrated and described herein with reference to FIGS. 4 and 6. It should be understood that the illustrated clients 506 and computing architectures illustrated and described herein are illustrative, and should not be construed as being limited in any way.

In the illustrated embodiment, the computing environment 502 includes application servers 508, data storage 510, and one or more network interfaces 512, According to various implementations, the functionality of the application servers 508 can be provided by one or more server computers that are executing as part of, or in communication with, the network 504. The application servers 508 can host various services, virtual machines, portals, and/or other resources. In the illustrated embodiment, the application servers 508 host one or more virtual machines 514 for hosting applications or other functionality. According to various implementations, the virtual machines 514 host one or more applications and/or software modules for providing the functionality described herein for enabling copy and paste functionality for videos, It should be understood that this embodiment is illustrative, and should not be construed as being limiting in any way. The application servers 508 also host or provide access to one or more Web portals, link pages, Web sites, and/or other information (“Web portals”) 516.

According to various implementations, the application servers 508 also include one or more mailbox services 518 and one or more messaging services 520. The mailbox services 518 can include electronic mail (“email”) services, The mailbox services 518 also can include various personal information management (“PIM”) services including, but not limited to, calendar services, contact management services, collaboration services, and/or other services. The messaging services 520 can include, but are not limited to, instant messaging services, chat services, forum services, and/or other communication services,

The application servers 508 also can include one or more social networking services 522. The social networking services 522 can include various social networking services including, but not limited to, services for sharing or posting status updates, instant messages, links, photos, videos, and/or other information; services for commenting or displaying interest in articles, products, blogs, or other resources; and/or other services. In some embodiments, the social networking services 522 are provided by or include the FACEBOOK social networking service, the LINKEDIN professional networking service, the MY SPACE social networking service, the FOURSQUARE geographic networking service, the YAMMER office colleague networking service, and the like. In other embodiments, the social networking services 522 are provided by other services, sites, and/or providers that may or may not explicitly be known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Washington. Other services are possible and are contemplated.

The social networking services 522 also can include commenting, blogging, and/or microbiogging services. Examples of such services include, but are not limited to, the YELP commenting service, the KUDZU review service, the OFFICETALK enterprise microblogging service, the TWITTER messaging service, the GOGGLE BUZZ service, and/or other services. It should be appreciated that the above lists of services are not exhaustive and that numerous additional and/or alternative social networking services 522 are not mentioned herein for the sake of brevity. As such, the above embodiments are illustrative, and should not be construed as being limited in any way.

As shown in FIG. 5, the application servers 508 also can host other services, applications, portals, and/or other resources (“other resources”) 524. The other resources 524 can include, but are not limited to, services provided by the overlay engine 102. It thus can be appreciated that the computing environment 502 can provide integration of the concepts and technologies disclosed herein provided herein for enabling copy and paste functionality for videos with various mailbox, messaging, social networking, and/or other services or resources. For example, the concepts and technologies disclosed herein can be used to allow users to share videos 112 with social networks and enable copy and paste functionality with social network members. This is just one example and should not be construed as being limiting in any way.

As mentioned above, the computing environment 502 can include the data storage 510. According to various implementations, the functionality of the data storage 510 is provided by one or more databases operating on, or in communication with, the network 504. The functionality of the data storage 510 also can be provided by one or more server computers configured to host data for the computing environment 502. The data storage 510 can include, host, or provide one or more real or virtual datastores 526A-526N (hereinafter referred to collectively and/or generically as “datastores 526”). The datastores 526 are configured to host data used or created by the application servers 508 and/or other data. Although not illustrated in FIG. 5, the datastores 526 also can host or store the playback application 108, the overlay generator 110, the video 112, and/or other data such as the output 120, if desired.

The computing environment 502 can communicate with, or be accessed by, the network interfaces 512. The network interfaces 512 can include various types of network hardware and software for supporting communications between two or more computing devices including, but not limited to, the clients 506 and the application servers 508. It should be appreciated that the network interfaces 512 also may be utilized to connect to other types of networks and/or computer systems.

It should be understood that the distributed computing environment 500 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 500 provides the software functionality described herein as a service to the clients 506. It should be understood that the clients 506 can include real or virtual machines including, but not limited to, server computers, web servers, personal computers, mobile computing devices, smart phones, and/or other devices. As such, various embodiments of the concepts and technologies disclosed herein enable any device configured to access the distributed computing environment 500 to utilize the functionality described herein for enabling copy and paste functionality for videos.

Turning now to FIG. 6, an illustrative computing device architecture 600 for a computing device that is capable of executing various software components described herein for enabling copy and paste functionality for videos is illustrated, according to one embodiment. The computing device architecture 600 is applicable to computing devices that facilitate mobile computing due, in part, to form factor, wireless connectivity, and/or battery-powered operation. In some embodiments, the computing devices include, but are not limited to, mobile telephones, tablet devices, slate devices, portable video game devices, and the like. Moreover, the computing device architecture 600 is applicable to any of the clients 606 shown in FIG. 6. Furthermore, aspects of the computing device architecture 600 may be applicable to traditional desktop computers, portable computers (e.g., laptops, notebooks, ultra-portables, and netbooks), server computers, and other computer systems, such as described herein with reference to FIG. 4. For example, the single touch and multi-touch aspects disclosed herein below may be applied to desktop computers that utilize a touchscreen or some other touch-enabled device, such as a touch-enabled track pad or touch-enabled mouse.

The computing device architecture 600 illustrated in FIG. 6 includes a processor 602, memory components 604, network connectivity components 606, sensor components 608, input/output components 610, and power components 612. In the illustrated embodiment, the processor 602 is in communication with the memory components 604, the network connectivity components 606, the sensor components 608, the input/output (“I/0”) components 610, and the power components 612. Although no connections are shown between the individuals components illustrated in FIG. 6, the components can interact to carry out device functions. In some embodiments, the components are arranged so as to communicate via one or more busses (not shown).

The processor 602 includes a central processing unit (“CPU”) configured to process data, execute computer—executable instructions of one or more application programs, and communicate with other components of the computing device architecture 600 in order to perform various functionality described herein. The processor 602 may be utilized to execute aspects of the software components presented herein and, particularly, those that utilize, at least in part, a touch-enabled input.

In sonic embodiments, the processor 602 includes a graphics processing unit (“GPU”) configured to accelerate operations performed by the CPU, including, but not limited to, operations performed by executing general-purpose scientific and engineering computing applications, as well as graphics-intensive computing applications such as high resolution video (e.g., 620P, 1080P, and greater), video games, three-dimensional (“3D”) modeling applications, and the like. In some embodiments, the processor 602 is configured to communicate with a discrete CPU (not shown). In any case, the CPU and GPU may be configured in accordance with a co-processing CPU/GPU computing model, wherein the sequential part of an application executes on the CPU and the computationally-intensive part is accelerated by the CPU.

In some embodiments, the processor 602 is, or is included in, a system-on-chip (“SoC”) along with one or more of the other components described herein below. For example, the SoC may include the processor 602, a CPU, one or more of the network connectivity components 606, and one or more of the sensor components 608. In some embodiments, the processor 602 is fabricated, in part, utilizing a package-on-package (“PoP”) integrated circuit packaging technique. Moreover, the processor 602 may be a single core or multi-core processor.

The processor 602 may be created in accordance with an ARM architecture, available for license from ARM HOLDINGS of Cambridge, United Kingdom. Alternatively, the processor 602 may be created in accordance with an x86 architecture, such as is available from INTEL CORPORATION of Mountain View, Calif. and others. In some embodiments, the processor 602 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 604 include a random access memory (“RAM”) 614, a read-only memory (“ROM”) 616, an integrated storage memory (“integrated storage”) 618, and a removable storage memory (“removable storage”) 620, In some embodiments, the RAM 614 or a portion thereof, the ROM 616 or a portion thereof, and/or some combination the RAM 614 and the ROM 616 is integrated in the processor 60:2, In some embodiments, the ROM 616 is configured to store a firmware, an operating system or a portion thereof (e.g., operating system kernel), and/or a bootloader to load an operating system kernel from the integrated storage 618 or the removable storage 620.

The integrated storage 618 can include a solid-state memory, a hard disk, or a combination of solid-state memory and a hard disk. The integrated storage 618 may be soldered or otherwise connected to a logic board upon which the processor 602 and other components described herein also may be connected. As such, the integrated storage 618 is integrated in the computing device. The integrated storage 618 is configured to store an operating system or portions thereof, application programs, data, and other software components described herein.

The removable storage 620 can include a solid-state memory, a hard disk, or a combination of solid-state memory and a hard disk. In sonic embodiments, the removable storage 620 is provided in lieu of the integrated storage 618. In other embodiments, the removable storage 620 is provided as additional optional storage. In some embodiments, the removable storage 620 is logically combined with the integrated storage 618 such that the total available storage is made available and shown to a user as a total combined capacity of the integrated storage 618 and the removable storage 620.

The removable storage 620 is configured to be inserted into a removable storage memory slot (not shown) or other mechanism by which the removable storage 620 is inserted and secured to facilitate a connection over which the removable storage 620 can communicate with other components of the computing device, such as the processor 602. The removable storage 620 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 604 can store an operating system. According to various embodiments, the operating system includes, but is not limited to, SYMBIAN OS from SYMBIAN LIMITED, WINDOWS MOBILE OS from Microsoft Corporation of Redmond, Washington, WINDOWS PHONE OS from Microsoft Corporation, WINDOWS from Microsoft Corporation, PALM WEBOS from Hewlett-Packard Company of Palo Alto, Calif., BLACKBERRY OS from Research in Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 606 include a wireless wide area network component (“WWAN component”) 622, a wireless local area network component (“WLAN component”) 624, and a wireless personal area network component (“WPAN component”) 626. The network connectivity components 606 facilitate communications to and from a network 628, which may be a WWAN, a WLAN, or a WPAN. Although a single network 628 is illustrated, the network connectivity components 606 may facilitate simultaneous communication with multiple networks. For example, the network connectivity components 606 may facilitate simultaneous communications with multiple networks via one or more of a WWAN, a WLAN, or a WPAN. In some embodiments, the network 628 is provided by one or more of the networks 104, 504. In some embodiments, the network 628 includes the networks 104, 504. In yet other embodiments, the network 628 provides access to the networks 104, 504.

The network 628 may be a WWAN, such as a mobile telecommunications network utilizing one or more mobile telecommunications technologies to provide voice and/or data services to a computing device utilizing the computing device architecture 600 via the WWAN component 622. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 628 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 628 may be configured to provide voice and/or data communications with any combination of the above technologies. The network 628 may be configured to or adapted to provide voice and/or data communications in accordance with future generation technologies,

In some embodiments, the WWAN component 622 is configured to provide dual- multi-mode connectivity to the network 628. For example, the WWAN component 622 may be configured to provide connectivity to the network 628, wherein the network 628 provides service via GSM and UMTS technologies, or via some other combination of technologies. Alternatively, multiple WWAN components 622 may be utilized to perform such functionality, and/or provide additional functionality to support other non-compatible technologies (i.e., incapable of being supported by a single WWAN component). The WWAN component 622 may facilitate similar connectivity to multiple networks (e.g., a UNITS network and an LTE network).

The network 628 may be a WEAN operating in accordance with one or more Institute of Electrical and Electronic Engineers (“IEEE”) 802.11 standards, such as IEEE 802,11a, 802.11b, 802.11g, 802,11n, and/or future 802.11 standard (referred to herein collectively as WI-FI). Draft 802.11 standards are also contemplated. In some embodiments, the WLAN is implemented utilizing one or more wireless WI-FI access points. In some embodiments, one or more of the wireless WI-FI access points are another computing device with connectivity to a WWAN that are functioning as a hotspot. The WEAN component 624 is configured to connect to the network 628 via the WI-FI access points, Such connections may be secured via various encryption technologies including, but not limited, WI-FI Protected Access (“WPA”), WPA2, Wired Equivalent Privacy (“WEP”), and the like.

The network 628 may be a WPAN operating in accordance with Infrared Data Association (“IrDA”), BLUETOOTH, wireless Universal Serial Bus (“USB”), Z-Wave, ZIGBEE, or some other short-range wireless technology. In some embodiments, the WPAN component 626 is configured to facilitate communications with other devices, such as peripherals, computers, or other computing devices via the WPAN.

The sensor components 608 include a magnetometer 630, an ambient light sensor 632, a proximity sensor 634, an accelerometer 636, a gyroscope 638, and a Global Positioning System sensor (“GPS sensor”) 640. It is contemplated that other sensors, such as, but not limited to, temperature sensors or shock detection sensors, also may be incorporated in the computing device architecture 600.

The magnetometer 630 is configured to measure the strength and direction of a magnetic field. In some embodiments the magnetometer 630 provides measurements to a compass application program stored within one of the memory components 604 in order to provide a user with accurate directions in a frame of reference including the cardinal directions, north, south, east, and west. Similar measurements may be provided to a navigation application program that includes a compass component. Other uses of measurements obtained by the magnetometer 630 are contemplated

The ambient light sensor 632 is configured to measure ambient light. In some embodiments, the ambient light sensor 632 provides measurements to an application program stored within one the memory components 604 in order to automatically adjust the brightness of a display (described below) to compensate for low-light and high-light environments. Other uses of measurements obtained by the ambient light sensor 632 are contemplated.

The proximity sensor 634 is configured to detect the presence of an object or thing in proximity to the computing device without direct contact. In some embodiments, the proximity sensor 634 detects the presence of a user's body (e.g., the user's face) and provides this information to an application program stored within one of the memory components 604 that utilizes the proximity information to enable or disable some functionality of the computing device. For example, a telephone application program may automatically disable a touchscreen (described below) in response to receiving the proximity information so that, the user's face does not inadvertently end a call or enable/disable other functionality within the telephone application program during the call. Other uses of proximity as detected by the proximity sensor 634 are contemplated.

The accelerometer 636 is configured to measure proper acceleration. In some embodiments, output from the accelerometer 636 is used by an application program as an input mechanism to control some functionality of the application program. For example, the application program may be a video game in which a character, a portion thereof, or an object is moved or otherwise manipulated in response to input received via the accelerometer 636. In some embodiments. output from the accelerometer 636 is provided to an application program for use in switching between landscape and portrait modes, calculating coordinate acceleration, or detecting a fall. Other uses of the accelerometer 636 are contemplated.

The gyroscope 638 is configured to measure and maintain orientation. In some embodiments, output from the gyroscope 638 is used by an application program as an input mechanism to control some functionality of the application program. For example, the gyroscope 638 can be used for accurate recognition of movement within a 3D environment of a video game application or some other application. In some embodiments, an application program utilizes output from the gyroscope 638 and the accelerometer 636 to enhance control of some functionality of the application program. Other uses of the gyroscope 638 are contemplated.

The UPS sensor 640 is configured to receive signals from GPS satellites for use in calculating a location. The location calculated by the GPS sensor 640 may be used by any application program that requires or benefits from location information. For example, the location calculated by the GPS sensor 640 may be used with a navigation application program to provide directions from the location to a destination or directions from the destination to the location. Moreover, the GPS sensor 640 may be used to provide location information to an external location-based service, such as E911 service. The GPS sensor 640 may obtain location information generated via WI-FI, WIMAX, and/or cellular triangulation techniques utilizing one or more of the network connectivity components 606 to aid the GPS sensor 640 in obtaining a location fix. The GPS sensor 640 may also be used in Assisted OPS (“A-GPS”) systems.

The I/O components 610 include a display 642, a touchscreen 644, a data I/O interface component (“data I/O”)646, an audio I/O interface component (“audio I/O”) 648, a video I/O interface component (“video I/O”) 650, and a camera 652. In some embodiments, the display 642 and the touchscreen 644 are combined, In sonic embodiments two or more of the data I/O component 646, the audio I/O component 648, and the video I/O component 650 are combined. The I/O components 610 may include discrete processors configured to support the various interface described below, or may include processing functionality built-in to the processor 602.

The display 642 is an output device configured to present information in a visual form. In particular, the display 642 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some embodiments, the display 642 is a liquid crystal display (“LCD”) utilizing any active or passive matrix technology and any backlighting technology (if used). In some embodiments, the display 642 is an organic light emitting diode (“OLED”) display. Other display types are contemplated.

The touchscreen 644 is an input device configured to detect the presence and location of a touch. The touchscreen 644 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen 644 is incorporated on top of the display 642 as a transparent layer to enable a user to use one or more touches to interact with objects or other information presented on the display 642. In other embodiments, the touchscreen 644 is a touch pad incorporated on a surface of the computing device that does not include the display 642. For example, the computing device may have a touchscreen incorporated on top of the display 642 and a touch pad on a surface opposite the display 642.

In sonic embodiments, the touchscreen 644 is a single-touch touchscreen. In other embodiments, the touchscreen 644 is a multi-touch touchscreen. In some embodiments, the touchscreen 644 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 644. As such, a developer may create gestures that are specific to a particular application program.

In some embodiments, the touchscreen 644 supports a tap gesture in which a user taps the touchscreen 644 once on an item presented on the display 642. The tap gesture may be used for various reasons including, but not limited to, opening or launching whatever the user taps such as, for example, the UI control 312 described above with reference to FIG. 3B. It should be understood that this embodiment is illustrative, and should not be construed as being limiting in any way. In some embodiments, the touchscreen 644 supports a double tap gesture in which a user taps the touchscreen 644 twice on an item presented on the display 642. The double tap gesture may be used for various reasons including, but not limited to, zooming in or zooming out in stages. In some embodiments, the touchscreen 644 supports a tap and hold gesture in which a user taps the touchscreen 644 and maintains contact for at least a pre-defined time. The tap and hold gesture may be used for various reasons including, but not limited to, opening a context-specific menu.

In some embodiments, the touchscreen 644 supports a pan gesture in which a user places a finger on the touchscreen 644 and maintains contact with the touchscreen 644 while moving the finger on the touchscreen 644. The pan gesture may be used for various reasons including, but not limited to, moving through screens, images, or menus at a controlled rate. Multiple finger pan gestures are also contemplated. In some embodiments, the touchscreen 644 supports a flick gesture in which a user swipes a finger in the direction the user wants the screen to move. The flick gesture may be used for various reasons including, but not limited to, scrolling horizontally or vertically through menus or pages. In some embodiments, the touchscreen 644 supports a pinch and stretch gesture in which a user makes a pinching motion with two fingers (e.g., thumb and forefinger) on the touchscreen 644 or moves the two fingers apart. The pinch and stretch gesture may be used for various reasons including, but not limited to, zooming gradually in or out of a website, map, or picture. For example, a user can use the pinch or stretch gesture to resize the video shown in FIGS. 3A-3E, if desired. Because pinch and stretch gestures can be used for other purposes, this embodiment should be understood as being illustrative and should not be construed as being limiting in any way.

Although the above gestures have been described with reference to the use one or more fingers for performing the gestures, other appendages such as toes or objects such as styluses may be used to interact with the touchscreen 644. As such, the above gestures should be understood as being illustrative and should not be construed as being limiting in any way.

The data I/O interface component 646 is configured to facilitate input of data to the computing device and output of data from the computing device. In some embodiments, the data I/O interface component 646 includes a connector configured to provide wired connectivity between the computing device and a computer system, for example, for synchronization operation purposes. The connector may be a proprietary connector or a standardized connector such as USB, micro-USB, mini-USB, or the like. In some embodiments, the connector is a dock connector for docking the computing device with another device such as a docking station, audio device (e.g., a digital music player), or video device.

The audio I/O interface component 648 is configured to provide audio input and/or output capabilities to the computing device. In some embodiments, the audio I/O interface component 646 includes a microphone configured to collect audio signals. In some embodiments, the audio I/O interface component 646 includes a headphone jack configured to provide connectivity for headphones or other external speakers. In some embodiments, the audio interface component 648 includes a speaker for the output of audio signals. In some embodiments, the audio I/O interface component 646 includes an optical audio cable out.

The video I/O interface component 650 is configured to provide video input and/or output capabilities to the computing device. In some embodiments, the video I/O interface component 650 includes a video connector configured to receive video as input from another device (e.g., a video media player such as a DVD or BLURAY player) or send video as output to another device (e.g., a monitor, a television, or some other external display). In some embodiments, the video I/O interface component 650 includes a High-Definition Multimedia Interface (“HDMI”), mini HDMI, micro-HDMI, DisplayPort, or proprietary connector to input/output video content, In some embodiments, the video I/O interface component 650 or portions thereof is combined with the audio I/O interface component 648 or portions thereof.

The camera 652 can be configured to capture still images and/or video. The camera 652 may utilize a charge coupled device (“CCD”) or a complementary metal oxide semiconductor (“CMOS”) image sensor to capture images. In some embodiments, the camera 652 includes a flash to aid in taking pictures in low-light environments. Settings for the camera 652 may be implemented as hardware or software buttons.

Although not illustrated, one or more hardware buttons may also be included in the computing device architecture 600. The hardware buttons may be used for controlling some operational aspect of the computing device. The hardware buttons may be dedicated buttons or multi-use buttons. The hardware buttons may be mechanical or sensor-based.

The illustrated power components 612 include one or more batteries 654, which can be connected to a battery gauge 656. The batteries 654 may be rechargeable or disposable. Rechargeable battery types include, but are not limited to, lithium polymer, lithium ion, nickel cadmium, and nickel metal hydride. Each of the batteries 654 may be made of one or more cells.

The battery gauge 656 can be configured to measure battery parameters such as current, voltage, and temperature. In some embodiments, the battery gauge 656 is configured to measure the effect of a battery's discharge rate, temperature, age and other factors to predict remaining life within a certain percentage of error. In some embodiments, the battery gauge 656 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 612 may also include a power connector, which may be combined with one or more of the aforementioned I/O components 610. The power components 612 may interface with an external power system or charging equipment via a power I/O component 644.

Based on the foregoing, it should be appreciated that technologies for enabling copy and paste functionality for videos and other media content have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

1. A computer-implemented method for displaying text associated with a video, the computer-implemented method comprising performing computer-implemented operations for:
obtaining video comprising a payload;
determining if the video comprises metadata; and
in response to determining that the video comprises the metadata,
analyzing the metadata to determine text associated with the video and a timing parameter defining a time at which the text is to be displayed;
generating, at an overlay engine, an overlay comprising the text and indicating the time at which the text is to be displayed; and
generating output comprising the payload and the overlay.

2. The method of claim further comprising presenting be output at the overlay engine.

3. The method of claim 1, further comprising storing the output at a data storage device.

4. The method of claim 1, further comprising presenting the overlay as a text box for presenting the text and enabling selection of the text.

5. The method of claim 4, wherein the text box is configured to enable copying of the text.

6. The method of claim 1, further comprising:
in response to determining that the video does not comprise the metadata, determining if the video includes displayed text; and
in response to determining that the video includes the displayed text,
detecting the displayed text in the video and determining the timing parameter based upon the time in the video at which the displayed text is displayed;
generating, at the overlay engine, the overlay comprising the displayed text and indicating the time at which the displayed text is to be displayed; and
generating the output comprising the payload and the overlay.

7. The method of claim 6, wherein detecting the displayed text comprises applying an optical character recognition operation to the video to detect the text,

8. The method of claim 1, further comprising presenting an option to display the text and, in response to detecting selection of the option, presenting the output at the overlay engine.

9. A computer storage medium having computer readable instructions stored thereupon that, when executed by a computer, cause the computer to:
obtain video comprising a payload and metadata;
analyze the metadata to determine text associated with the video and a timing parameter defining a time at which the text is to be displayed;
generate, at the computer, an overlay comprising the text and indicating the time at which the text is to be displayed during playback of the video;
generate output comprising the payload and the overlay; and
display the output at the computer.

10. The computer storage medium of claim 9, further comprising computer-executable instructions that, when executed by the computer, cause the computer to present the overlay as a text box for presenting the text and enabling selection of the text.

11. The computer storage medium of claim 10, wherein the text box is configured to enable copying of the text.

12. The computer storage medium of claim 9, wherein the metadata comprises at least one instance of text content information and at least one instance of timing information.

13. The computer storage medium of claim 12, wherein the metadata further comprises styles information, positioning information, and actions information.

14. The computer storage medium of claim 9, further comprising computer-executable instructions that, when executed by the computer, cause the computer to:
determine if the metadata comprises metadata describing text associated with the video; and
in response to a determination that the video does not comprise the metadata describing the text, determine if the video includes displayed text; and
in response to a determination that the video includes the displayed text,
detect the displayed text in the video;
generate, at the computer, the overlay comprising the displayed text; and
generate the output comprising the payload and the overlay.

15. The computer storage medium of claim 14, further comprising computer-executable instructions that, when executed by the computer, cause the computer to:
present an option to display the text; and
in response to selection of the option, present the output at the computer.

16. The computer storage medium of claim 9, further comprising computer-executable instructions that, when executed by the computer, cause the computer to:
present an option to display the text; and
in response to selection of the option, present the output at the computer.

17. The computer storage medium of claim 9, wherein the video is obtained from a video source in communication with the computer via a communications network.

18. A computer storage medium having computer readable instructions stored thereupon that, when executed by a computer, cause the computer to:
obtain video comprising a payload and metadata describing text associated with the video, the metadata comprising data defining at least one instance of text content information and at least one instance of timing information;
analyze the at least one instance of text content information to determine text associated with the video;
analyze the at least one instance of the timing information to determine a timing parameter defining a time at which the text is to be displayed;
generate, at the computer, an overlay comprising the text and indicating the time at which the text is to be displayed; and
generate output comprising the payload and the overlay.

19. The computer storage medium of claim 17, further comprising computer-executable instructions that, when executed by the computer, cause the computer to:
present the output at the computer, wherein the overlay is presented as a text box for presenting the text, enabling selection of the text, and enabling copying of the text.

20. The computer storage medium of claim 17, further comprising computer-executable instructions that, when executed by the computer, cause the computer to:
present, during playback of the video, playback controls comprising a user interface control for displaying the text; and
in response to selection of the user interface control, present the output at the overlay computer, wherein the overlay is presented as a text box for presenting the text and enabling selection of the text.
